(19) United States
(12) Patent Application Publication
(10) Pub. No.: US 2020/0186755 A1
(43) Pub. Date: Jun. 11, 2020

(54) DISPLAY CONTROL DEVICE AND DISPLAY CONTROL METHOD

(71) Applicant: PANASONIC INTELLECTUAL PROPERTY MANAGEMENT CO., LTD., Osaka (JP)

(72) Inventors: Shigekazu MIYAGAKI, Kanagawa (JP); Masanobu KANAYA, Kanagawa (JP)

(73) Assignee: PANASONIC INTELLECTUAL PROPERTY MANAGEMENT CO., LTD., Osaka (JP)

(21) Appl. No.: 16/304,917

(22) PCT Filed: Apr. 26, 2017
(86) PCT No.: PCT/JP2017/016511

§ 371 Date: Nov. 27, 2018

(30) Foreign Application Priority Data
May 31, 2016 (JP) 2016-109099

(51) Int. Cl. H04N 7/18; G09G 5/14; B60R 1/00; B60R 1/02

(52) U.S. Cl. CPC H04N 7/181; G09G 5/14; B60R 1/006; B60R 2001/1253; B60R 2300/105; B60R 2300/302; B60R 1/02

(57) ABSTRACT

An image acquisition unit acquires a first image corresponding to a rear view from a vehicle, a second image corresponding to a left view from the vehicle in a rearward direction, and a third image corresponding to a right view from the vehicle in the rearward direction. An image processor generates, when a speed is greater than or equal to a first threshold, an image by superimposing a fourth image on the second image and the third image, the fourth image resulting from preventing a first predetermined range corresponding to a lower portion of the first image from being displayed. The image processor generates, when the speed is less than a second threshold, an image by superimposing a fifth image on the second image and the third image, the fifth image resulting from preventing a second predetermined range corresponding to both end portions of the first image from being displayed.

### TECHNICAL FIELD

The present invention relates to a display control device and a display control method that display an image corresponding to a rear view from a vehicle and an image corresponding to each rear-side view from the vehicle.

### BACKGROUND ART

As a rear viewing field assistance system that assists a driver driving a vehicle to check a rear view and rear-side views, such a conventional system is known that displays a plurality of images taken of a rear view and rear-side views from the vehicle on a presentation unit such as a display installed in the vehicle (for example, PTL 1).

### CITATION LIST

### Patent Literature

PTL 1: Unexamined Japanese Patent Publication No. 2005-328181.

### SUMMARY OF THE INVENTION

The present invention provides a display control device and a display control method that prevent volume of information to be viewed by a driver from being excessive but allow information necessary for the driver to be displayed when a plurality of images taken of a rear view and rear-side views from a vehicle are composited and displayed.

A display control device according to the present invention includes an image acquisition unit, a travel state detector, and an image processor. The image acquisition unit acquires a first image corresponding to a rear view from a vehicle, a second image corresponding to a left view from the vehicle in a rearward direction, and a third image corresponding to a right view from the vehicle in the rearward direction. The travel state detector detects a speed of the vehicle. The image processor generates, when the speed is greater than or equal to a first threshold, an image by superimposing a fourth image on the second image and the third image, the fourth image resulting from preventing a first predetermined range corresponding to a lower portion of the first image from being displayed. The image processor generates, when the speed is less than a second threshold, an image by superimposing a fifth image on the second image and the third image, the fifth image resulting from preventing a second predetermined range corresponding to both end portions of the first image from being displayed.

A display control method according to the present invention includes acquiring a first image, a second image, and a third image, detecting a speed, generating an image by superimposing a fourth image, and generating an image by superimposing a fifth image. In acquiring a first image, a second image, and a third image, a first image corresponding to a rear view from a vehicle, a second image corresponding to a left view from the vehicle in a rearward direction, and a third image corresponding to a right view from the vehicle in the rearward direction are acquired. In detecting a speed, a speed of the vehicle is detected. In generating an image by superimposing a fourth image, when the speed is greater than or equal to a first threshold, an image by superimposing a fourth image on the second image and the third image is generated, the fourth image resulting from preventing a first predetermined range corresponding to a lower portion of the first image from being displayed. In generating an image by superimposing a fifth image, when the speed is less than a second threshold, an image by superimposing a fifth image on the second image and the third image is generated, the fifth image resulting from preventing a second predetermined range corresponding to both end portions of the first image from being displayed.

According to the present invention, when a plurality of images taken of a rear view and rear-side views from a vehicle are composited and displayed, volume of information to be viewed by a driver is prevented from being excessive, while information necessary for the driver can be displayed.

### BRIEF DESCRIPTION OF DRAWINGS

FIG. 1 is a block diagram showing an example of a configuration of a display control device according to an exemplary embodiment of the present invention,

FIG. 2 is a diagram showing an example of a position and an imaging range of an imaging unit according to the exemplary embodiment of the present invention.

FIG. 3A is a diagram showing examples of taken images.

FIG. 3B is a diagram showing a first example of an image resulting from compositing the taken images.

FIG. 3C is a diagram showing a second example of the image resulting from compositing the taken images.

FIG. 4A is a diagram showing an example of an image displayed when a vehicle is at a stop.

FIG. 4B is a diagram showing an example of an image displayed when the vehicle is traveling,

FIG. 5A is a diagram showing an example of the image displayed when the vehicle is at a stop.

FIG. 5B is a diagram showing an example of an image displayed when the vehicle is traveling at a speed less than a predetermined speed.

FIG. 50 is a diagram showing an example of an image displayed when the vehicle is traveling at a speed greater than or equal to the predetermined speed.

FIG. 6 is a flowchart showing an example of an image process according to the exemplary embodiment of the present invention.

FIG. 7A is a diagram showing another example of the image displayed when the vehicle is at a stop.

FIG. 7B is a diagram showing another example of the image displayed when the vehicle is traveling at a speed less than the predetermined speed.

FIG. 70 is a diagram showing another example of the image displayed when the vehicle is traveling at a speed greater than or equal to the predetermined speed.

FIG. 8A is a diagram showing still another example of the image displayed when the vehicle is traveling at a speed less than the predetermined speed.

FIG. 8B is a diagram showing yet another example of the image displayed when the vehicle is traveling at a speed greater than or equal to the predetermined speed.

### DESCRIPTION OF EMBODIMENT

Before an exemplary embodiment of the present invention is described, problems found in a conventional technique will be briefly described. In a plurality of images taken of a rear view and rear-side views from a vehicle, the same scene (for example, an object such as a vehicle) is redundantly shown. Thus, when the plurality of images are displayed simultaneously, volume of information to be viewed by a driver becomes excessive. This requires that the plurality of images are composited together and then displayed. On the other hand, the plurality of images taken of the rear view and the rear-side views from the vehicle include a scene (for example, an object such as a vehicle) that is unique to each of the images. Therefore, inappropriate composition causes the object unique to each of the images to be hidden, which prevents information necessary for the driver from being displayed.

Hereinafter, the exemplary embodiment of the present invention will be described in detail with reference to the drawings. The exemplary embodiment described below is only illustrative, and the present invention is not limited to the exemplary embodiment.

### Exemplary Embodiment

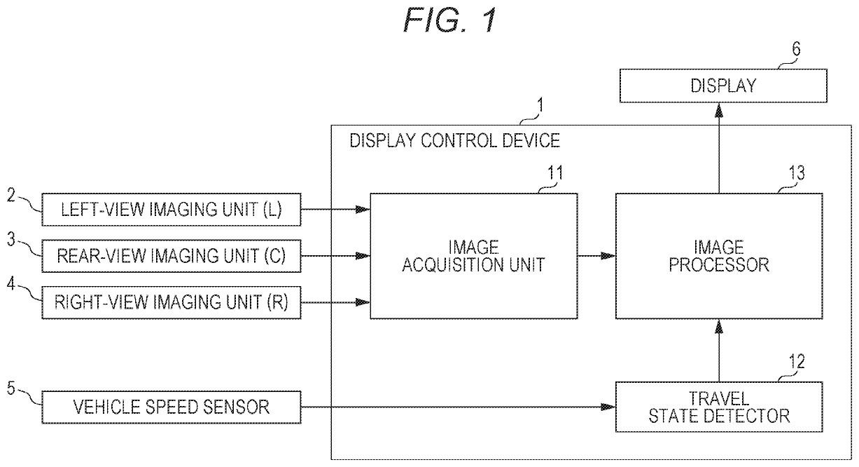

FIG. 1 is a block diagram showing an example of a configuration of display control device 1 according to the exemplary embodiment of the present invention. Display control device 1 is connected to left-view imaging unit 2, rear-view imaging unit 3, right-view imaging unit 4, vehicle speed sensor 5, and display 6. Display control device 1 includes image acquisition unit 11, travel state detector 12, and image processor 13.

Left-view imaging unit 2 is an imaging device such as a camera that is disposed on a left side in a backward direction (that is, on a right side of a vehicle in a forward direction) and takes an image of a rear-left view in the backward direction (hereinafter, referred to as a left-view image). For example, the left-view image taken by left-view imaging unit 2 corresponds to a mirror image on a side-view mirror disposed on the right side in the forward direction.

Rear-view imaging unit 3 is an imaging device such as a camera that is disposed on a rear end of the vehicle and takes an image of a rear view from the vehicle (hereinafter, referred to as a rear-view image).

Right-view imaging unit 4 is an imaging device such as a camera that is disposed on a right side in the backward direction (that is, on a left side of the vehicle in the forward direction) and takes an image of a rear right view in the backward direction (hereinafter, referred to as a right-view image). For example, the right-view image taken by right-view imaging unit 4 corresponds to a mirror image on a side-view mirror disposed on the left side in the forward direction.

Vehicle speed sensor 5 is a sensor that detects a speed of the vehicle (vehicle speed). Display 6 is disposed at a position in the vehicle where the driver easily views and displays an image generated by image processor 13.

Image acquisition unit 11 acquires the left-view image taken by left-view imaging unit 2, the rear-view image taken by rear-view imaging unit 3, and the right-view image taken by right-view imaging unit 4. Then, image acquisition unit 11 outputs, to image processor 13, the three images thus acquired, Image acquisition unit 11 may make adjustments to brightness, contrast, and the like of each of the images before outputting the images to image processor 13.

Travel state detector 12 acquires, as a travel state of the vehicle, the vehicle speed detected by vehicle speed sensor 5. Travel state detector 12 outputs, to image processor 13, the vehicle speed thus acquired.

Image processor 13 performs an image process for compositing the left-view image, the rear-view image, and the right-view image. At that time, image processor 13 changes the image process in accordance with the vehicle speed. Image processor 13 outputs a generated image to display 6. The image process performed by image processor 13 will be described below.

Display 6 is disposed at a position in the vehicle where the driver easily views and displays the image generated by image processor 13.

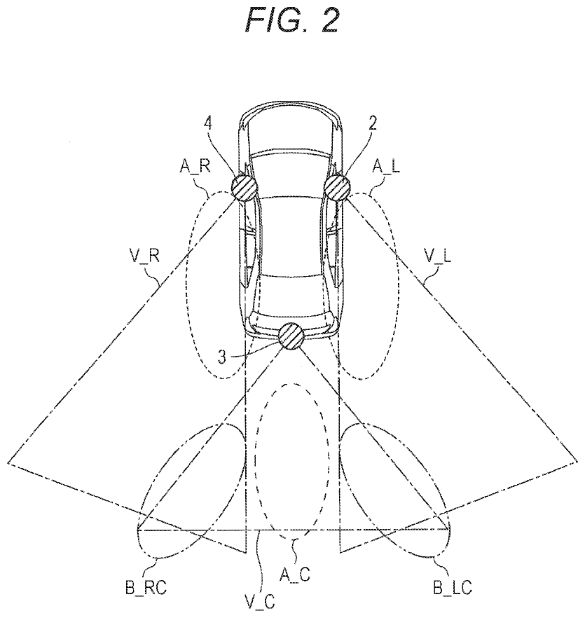

Next, respective imaging ranges of left-view imaging unit 2, rear-view imaging unit 3, and right-view imaging unit 4 will be described with reference to FIG. 2.

FIG. 2 is a diagram showing an example of a position and an imaging range of each of the imaging units according to the exemplary embodiment of the present invention. FIG. 2 shows respective positions where left-view imaging unit 2, rear-view imaging unit 3, and right-view imaging unit 4 are disposed on the vehicle, imaging range V_L of left-view imaging unit 2, imaging range V_C of rear-view imaging unit 3, and imaging range V_R of right-view imaging unit if.

Imaging range V_L of left-view imaging unit 2 includes a range where only left-view imaging unit 2 can take an image (for example, range A_L), and a range where both left-view imaging unit 2 and rear-view imaging unit 3 can take an image (for example, range B_LC). Further, imaging range V_R of right-view imaging unit 4 includes a range where only right-view imaging unit 4 can take an image (for example, range A_R), and a range where both right-view imaging unit 4 and rear-view imaging unit 3 can take an image (for example, range B_RC). Further, imaging range V_C of rear-view imaging unit 3 includes a range where only rear-view imaging unit 3 can take an image (for example, range A_C), the range where both left-view imaging unit 2 and rear-view imaging unit 3 can take an image (for example, range B_LC), and the range where both right-view imaging unit 4 and rear-view imaging unit 3 can take an image (for example, range B_RC).

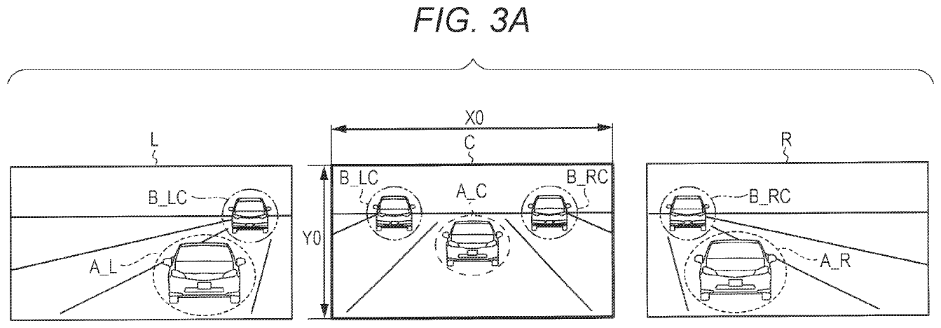

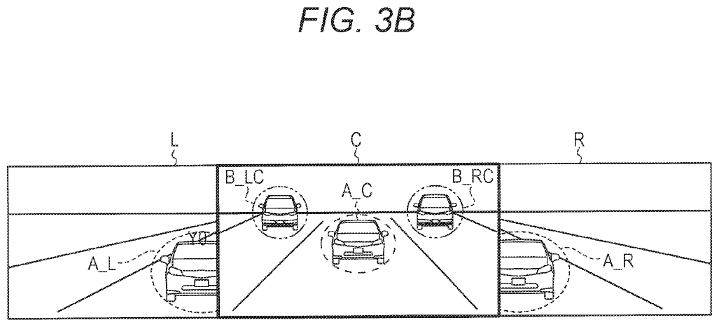

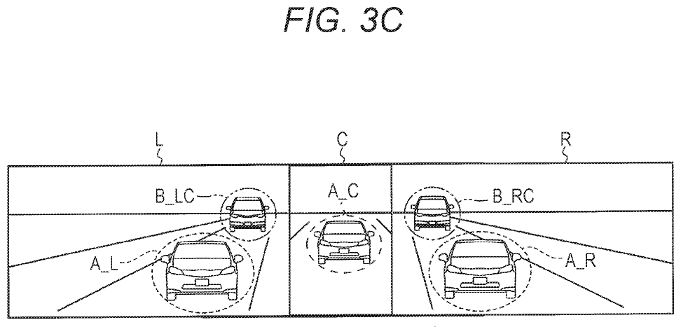

Next, three images taken by left-view imaging unit 2, rear-view imaging unit 3, and right-view imaging unit 4, and the image process for compositing the three images will be described with reference to FIG. 3A to FIG. 3C.

FIG. 3A is a diagram showing examples of taken images. FIG. 3A shows left-view image L taken by left-view imaging unit 2, rear-view image C taken by rear-view imaging unit 3, and right-view image R taken by right-view imaging unit 4.

Horizontal and vertical widths of rear-view image C are denoted by X0 and Y0, respectively. In range A_L and range B_LC in left-view image L, different vehicles are shown. In range A_C, range B_LC, and range B_RC in rear-view image C, different vehicles are shown. In range A_R and range B_RC of right-view image R, different vehicles are shown.

As described with reference to FIG. 2, range B_LC is a range where both left-view imaging unit 2 and rear-view imaging unit 3 can take an image; thus, the vehicles shown in range B_LC are identical to each other. Similarly range B_RC is a range where both right-view imaging unit 4 and rear-view imaging unit 3 can take an image; thus, the vehicles shown in range B_RC are identical to each other.

For example, when the three images in FIG. 3A are displayed side by side on a display or the like, as in range B_LC, range B_RC, the same vehicle is redundantly displayed, which makes volume of information excessive. Therefore, to prevent the same vehicle from being redundantly displayed, the image process for compositing images is performed.

FIG. 3B is a diagram showing a first example of an image resulting from compositing taken images. FIG. 3C is a diagram showing a second example of the image resulting from compositing the taken images.

In FIG. 3B, rear-view image C is arranged in a foreground, left-view image L is arranged behind rear-view image C such that the same vehicles shown in range B_LC are placed on top of each other, and right-view image R is arranged behind rear-view image C such that the same vehicles shown in range B_RC are placed on top of each other.

In FIG. 3C, rear-view image C is arranged in a background, left-view image L is arranged on top of rear-view image C such that the same vehicles shown in range B_LC are placed on top of each other, and right-view image R is arranged on top of rear-view image C such that the same vehicles shown in range B_RC are placed on top of each other.

An image process for compositing the images shown in FIG. 3B can prevent the same vehicle from being redundantly displayed. This causes, however, vehicles shown in range A_L and range A_R, to partially disappear. That is, in the example of the image shown in FIG. 3B, the range where only left-view imaging unit 2 can take an image and the range where only right-view imaging unit 4 can take an image may disappear.

Further, an image process for compositing the images shown in FIG. 3C can prevent the same vehicle from being redundantly displayed and allows the range where only left-view imaging unit 2 can take an image and the range where only right-view imaging unit 4 can take an image to be displayed. This reduces, however, the horizontal width of the range where rear-view image C is displayed. In particular, when the image shown in FIG. 3C is displayed when the vehicle is traveling, the image whose horizontal width is smaller changes fast, which imposes a burden on the driver.

Therefore, image processor 13 of display control device 1 according to the present exemplary embodiment prevents part of rear-view image C from being displayed in accordance with the vehicle speed and sets rear-view image C, part of which is prevented from being displayed, as a to-be-displayed rear-view image. Then, image processor 13 performs the image process for compositing the to-be-displayed rear-view image, left-view image L, and right-view image R to generate an image to be displayed on display 6.

Note that, in the present exemplary embodiment, a description will be given of an example where image processor 13 crops out (cuts out) part of rear-view image C to prevent the part of rear-view image C from being displayed.

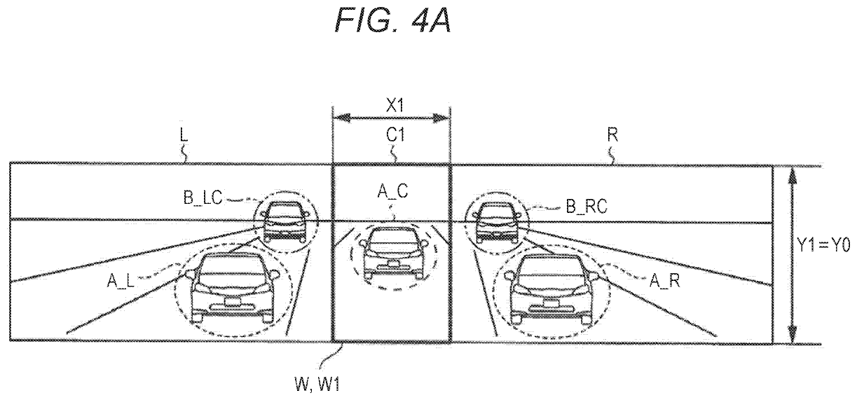

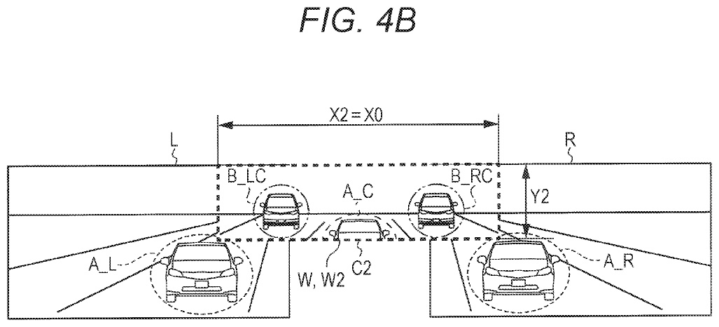

FIG. 4A is a diagram showing an example of an image displayed when the vehicle is at a stop. FIG. 4B is a diagram showing an example of an image displayed when the vehicle is traveling. Each of the images shown in FIG. 4A and FIG. 4B is an example of the image that results from compositing the three images shown in FIG. 3A and is displayed in a display area of display 6, the image including the to-be-displayed rear-view image corresponding to rear-view image C enclosed by frame W, and left-view image L and right-view image R that are composited together with the to-be-displayed rear-view image.

The image shown in FIG. 4A is an image where to-be-displayed rear-view image C1. (a fifth image) is arranged in the foreground, to-be-displayed rear-view image C1 resulting from cropping rear-view image C (a first image) such that a predetermined range (a second predetermined range) corresponding to both left and right end portions of rear-view image C is not displayed, and left-view image L (a second image) and right-view image R (a third image) are arranged behind to-be-displayed rear-view image C1. Horizontal and vertical widths of to-be-displayed rear-view image C1 are denoted by X1 and Y1, respectively. Then, a relation of X1<X0, Y1=Y0 is satisfied. Further, on a periphery of to-be-displayed rear-view image C1, frame W1 is displayed.

Further, the image shown in FIG. 4B is an image where to-be-displayed rear-view image C2 (a fourth image) is arranged in the foreground, to-be-displayed rear-view image C2 resulting from cropping rear-view image C (the first image) such that a predetermined range (a first predetermined range) corresponding to a lower portion of rear-view image C is not displayed, and left-view image L (the second image) and right-view image R (the third image) are arranged behind to-be-displayed rear-view image C2. Horizontal and vertical widths of to-be-displayed rear-view image C2 are denoted by X2 and Y2, respectively. Then, a relation of X2=X0, Y2<Y0 is satisfied. Further, on a periphery of to-be-displayed rear-view image C2, frame W2 is displayed.

Frame W1 is a red frame, and frame W2 is a blue frame. Note that frame W1 and frame W2 are not limited to the red frame and the blue frame, respectively; and it is sufficient that frame W1 and frame W2 are different from each other in display form. Display of frame W1, frame W2 allows a boundary between the images taken by the imaging units to be clearly shown. Further, the configuration where frame W1 and frame W2 are different from each other in display form allows a state where the vehicle is traveling or the vehicle is at a stop to be clearly shown. Note that the display of frame W1, frame W2 is not essential, which may eliminate the necessity for the display of frame W1, frame W2.

Image processor 13 generates such an image as shown in FIG. 4A when the vehicle is at a stop, that is, the vehicle speed is zero. Specifically, image processor 13 crops out the second predetermined range from rear-view image C and sets rear-view image C from which the second predetermined range has been cropped out as to-be-displayed rear-view image C1. Further, image processor 13 provides red frame W1 on the periphery of to-be-displayed rear-view image C1, Then, image processor 13 arranges to-be-displayed rear-view image C1 in the foreground and left-view image L and right-view image R behind to-be-displayed rear-view image C1 for image composition.

Image processor 13 generates such an image as shown in FIG. 4B when the vehicle is traveling, that is, the vehicle speed is not zero. Specifically image processor 13 crops out the first predetermined range from rear-view image C and sets rear-view image C from which the first predetermined range has been cropped out as to-be-displayed rear-view image C2. Further, image processor 13 provides blue frame W2 on the periphery of to-be-displayed rear-view image C2. Then, image processor 13 arranges to-be-displayed rear-view image C2 in the foreground and left-view image L and right-view image R behind to-be-displayed rear-view image C2 for image composition.

Note that the arrangement of the to-be-displayed rear-view image (C1 or C2), left-view image L, and right-view image R causes ranges where the imaging units redundantly take images in their respective imaging ranges to be placed on top of each other. This arrangement is adjusted in advance in accordance with the imaging range of each of the imaging units and stored in a storage unit (not shown).

As described above, image processor 13 determines whether the vehicle is at a stop or the vehicle is traveling based on the vehicle speed and generates an image to be displayed on display 6 using the image process selected in accordance with the determination result. The selection of the image process in accordance with the determination result allows, when the vehicle is at a stop, rear-view image C including the lower portion, the range where only left-view imaging unit 2 can take an image (range. A_L), and the range where only right-view imaging unit 4 can take an image (range A_R) to be displayed as shown in FIG. 4A. Further, the selection of the image process in accordance with the determination result prevents, when the vehicle is traveling, the lower portion of rear-view image C from being displayed but allows the range where only left-view imaging unit 2 can take an image (range A_L) and the range where only right-view imaging unit 4 can take an image (range A_R) to be displayed as shown in FIG. 4B.

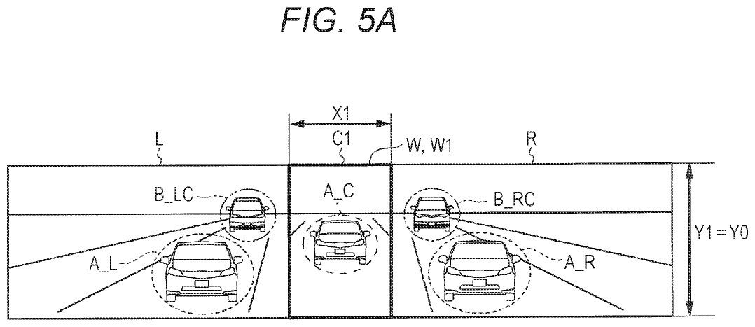

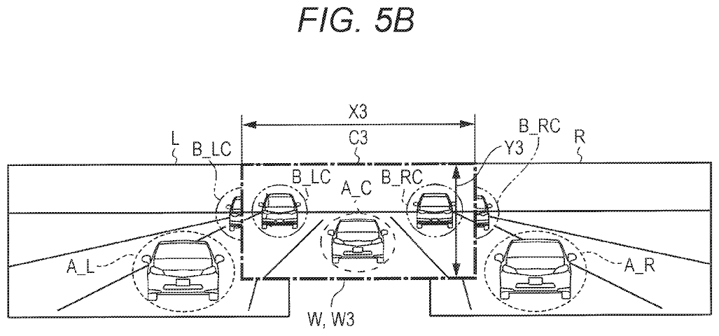

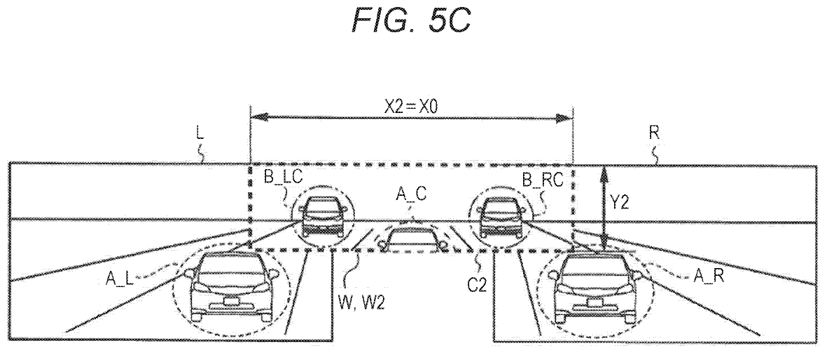

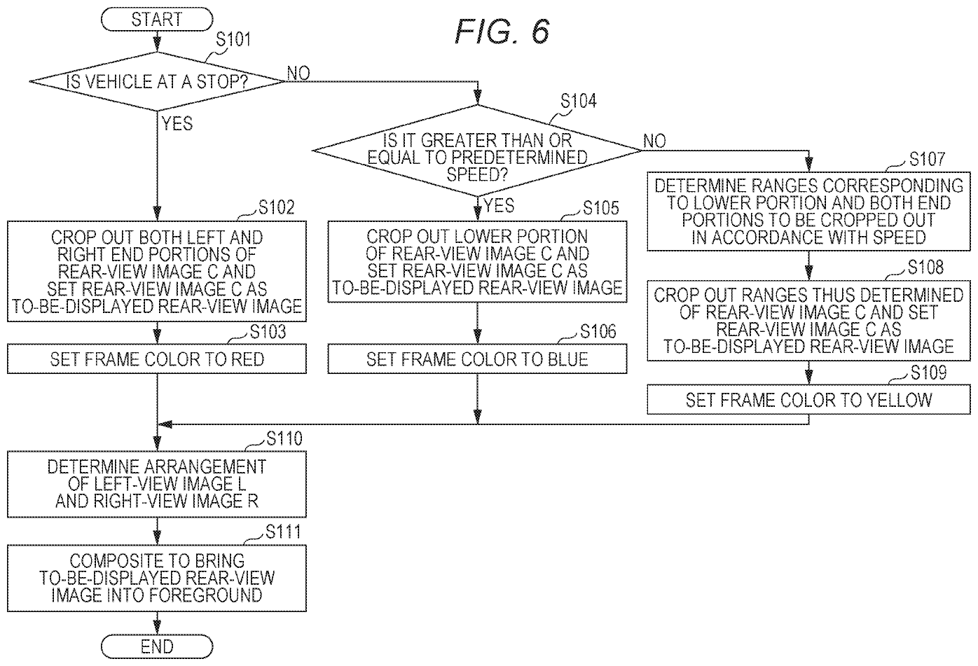

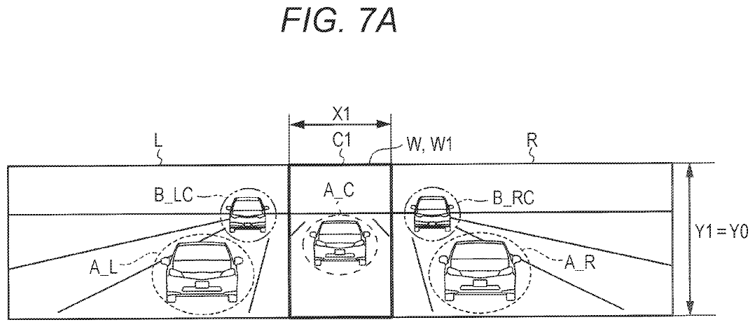

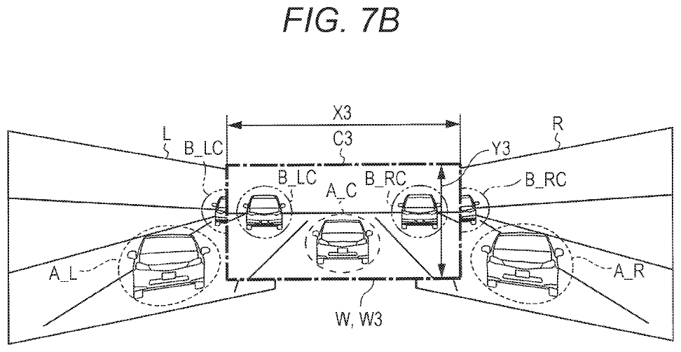

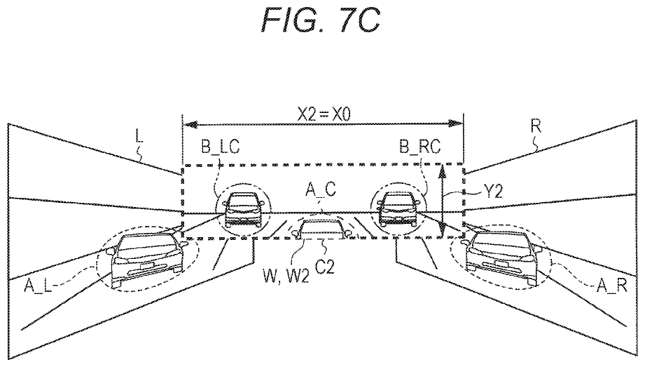

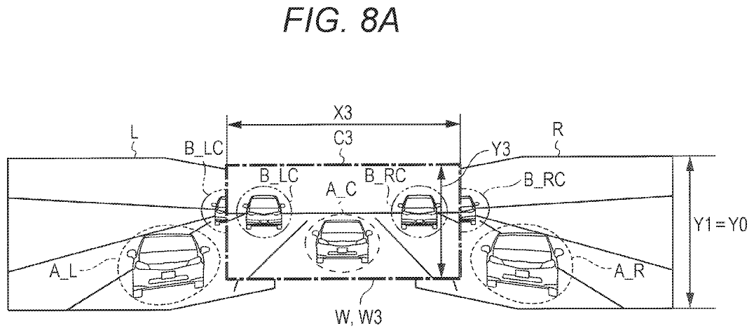

Note that, in FIG. 4A and FIG. 4B, a description has been given of an example where, in accordance with a state where the vehicle is at a stop or the vehicle is traveling, image processor 13 selects the image process. Note that image processor 13 may perform an image process that causes a gradual transition of the image in accordance with a change in the vehicle speed. Hereinafter, an example of this image process will be described with reference to FIG. 5A to FIG. 5G.

FIG. 5A is a diagram showing an example of the image displayed when the vehicle is at a stop. FIG. 5B is a diagram showing an example of an image displayed when the vehicle is traveling at a speed less than a predetermined speed. FIG. 5C is a diagram showing an example of an image displayed when the vehicle is traveling at a speed greater than or equal to the predetermined speed. Each of the images shown in FIG. 5A, FIG. 5B, and FIG. 5C is an example of the image that is displayed in the display area of display 6, the image including the to-be-displayed rear-view image corresponding to rear-view image C enclosed by frame W and left-view image L and right-view image R that are composited together with the to-be-displayed rear-view image.

The image shown in FIG. 5A is an image where to-be-displayed rear-view image C1 is arranged in the foreground, to-be-displayed rear-view image C1 resulting from cropping rear-view image C such that the second predetermined range is not displayed, and left-view image L and right-view image R are arranged behind to-be-displayed rear-view image C1, Horizontal and vertical widths of the to-be-displayed rear-view image are denoted by X1 and Y1, respectively. Then, a relation of X1<X0, Y1=Y0 is satisfied. Further, on the periphery of to-be-displayed rear-view image C1, frame W1 is displayed.

The image shown in FIG. 5B is an image where to-be-displayed rear-view image C3 (a sixth image) is arranged in the foreground, to-be-displayed rear-view image C3 resulting from cropping rear-view image C such that a range smaller than the second predetermined range corresponding to both the left and right end portions and a range smaller than the first predetermined range corresponding to the lower portion are not displayed. Left-view image L and right-view image R are arranged behind to-be-displayed rear-view image C3. Horizontal and vertical widths of to-be-displayed rear-view image C3 are denoted by X3 and Y3, respectively. Further, on a periphery of the to-be-displayed rear-view image, frame W3 is displayed.

The image shown in FIG. 5C is an image where to-be-displayed rear-view image C2 is arranged in the foreground, to-be-displayed rear-view image C2 resulting from cropping rear-view image C such that the first predetermined range is not displayed, and left-view image L and right-view image R are arranged behind to-be-displayed rear-view image C2. Horizontal and vertical widths of to-be-displayed rear-view image C2 are denoted by X2 and Y2, respectively. Then, a relation of X2=X0, Y2<Y0 is satisfied. Further, on the periphery of to-be-displayed rear-view image C2, frame W2 is displayed.

Note that a relation of X1, X2, X3 satisfies X2>X3>X1. Further, a relation of Y1, Y2, Y3 satisfies Y1>Y3>Y2.

Further, frame W1 is a red frame, frame W2 is a blue frame, and frame W3 is a yellow frame. Note that frame W1, frame W2, and frame W3 are not limited to the red frame, the blue frame, and the yellow frame, respectively and it is sufficient that frame W1, frame W2, and frame W3 are different from each other in display form. Display of frame W1 to frame W3 allows a boundary between the images taken by the imaging units to be clearly shown. Further, the configuration where frame W1 to frame W3 are different from each other in display form allows a state where the vehicle is at a stop, the vehicle is traveling at a low speed, or the vehicle is travelling at a high speed to be clearly shown. Note that the display of frame W1 to frame W3 is not essential, which may eliminate the necessity for the display of frame W1 to frame W3.

Image processor 13 generates such an image as shown in FIG. 5A when the vehicle is at a stop; that is, the vehicle speed is zero. Specifically image processor 13 crops out the second predetermined range from rear-view image C and sets rear-view image C from which the second predetermined range has been cropped out as to-be-displayed rear-view image C1, Further, image processor 13 provides red frame W1 on the periphery of to-be-displayed rear-view image C1. Then, image processor 13 arranges to-be-displayed rear-view image C1 in the foreground and left-view image L and right-view image R behind to-be-displayed rear-view image C1 for image composition.

Image processor 13 generates such an image as shown in FIG. 5B when the vehicle is traveling at a speed less than the predetermined speed. Specifically, image processor 13 determines, based on a difference between the vehicle speed and the predetermined speed, the range corresponding to the lower portion to be cropped out and the range corresponding to both the left and right end portions to be cropped out. The range corresponding to both the left and right end portions determined by image processor 13 is larger than zero but smaller than the second predetermined range. Further, the range corresponding to the lower portion determined by image processor 13 is larger than zero but smaller than the first predetermined range.

For example, image processor 13 determines the range corresponding to both the left and right end portions to be cropped out, the range being narrower than the second predetermined range and becoming narrower as the difference between the predetermined speed and the vehicle speed becomes larger. Then, image processor 13 determines the range corresponding to the lower portion to be cropped out, the range being narrower than the first predetermined range and becoming narrower as the difference between the predetermined speed and the vehicle speed becomes smaller.

That is, when the vehicle is traveling at a speed less than the predetermined speed, the range corresponding to both the left and right end portions to be cropped out monotonically decreases with respect to the vehicle speed, and the range corresponding to the lower portion to be cropped out monotonically increases with respect to the vehicle speed.

Then, image processor 13 crops out, from rear-view image C, the range corresponding to both the left and right end portions and the range corresponding to lower portion thus determined, and sets, as to-be-displayed rear-view image C3, rear-view image C from which the range corresponding to both the left and right end portions and the range corresponding to lower portion determined have been cropped out. Further, image processor 13 provides yellow frame W3 on a periphery of to-be-displayed rear-view image C3. Then, image processor 13 arranges to-be-displayed rear-view image C3 in the foreground and left-view image L and right-view image R behind to-be-displayed rear-view image C3 for image composition.

Image processor 13 generates such an image as shown in FIG. 5C when the vehicle is traveling at a speed greater than or equal to the predetermined speed. Specifically, image processor 13 crops out the first predetermined range from rear-view image C and sets rear-view image C from which the first predetermined range has been cropped out as to-be-displayed rear-view image C2. Further, image processor 13 provides blue frame W2 on the periphery of to-be-displayed rear-view image C2. Then, image processor 13 arranges to-be-displayed rear-view image C2 in the foreground and left-view image L and right-view image R behind to-be-displayed rear-view image C2 for image composition.

As described above, image processor 13 performs an image process that causes a gradual transition of the image in accordance with the vehicle speed. That is, an increase in the vehicle speed causes a transition of the image such that the horizontal width of the to-be-displayed rear-view image gradually increases and the vertical width gradually decreases as shown in FIG. 5B during transformation from the image shown in FIG. 5A to the image shown in FIG. 5C. Further, during the transition, the range where only left-view imaging unit 2 can take an image (range A_L) and the range where only right-view imaging unit 4 can take an image (range A_R) are displayed.

Next, a flow of the image process according to the present exemplary embodiment will be described below with reference to FIG. 6. FIG. 6 is a flowchart showing an example of the image process according to the present exemplary embodiment. The image process shown in FIG. 6 is initiated when, for example, the driver starts an engine of the vehicle and is repeatedly performed in accordance with a change in the vehicle speed while the vehicle is traveling. Then, the image process shown in FIG. 6 comes to an end when, for example, the driver stops the engine of the vehicle.

Image processor 13 determines, based on the vehicle speed acquired from travel state detector 12, whether the vehicle is at a stop (S101).

When the vehicle is at a stop (YES in S101), image processor 13 crops out the predetermined range (the second predetermined range) corresponding to both the left and right end portions from the rear-view image and sets the rear-view image from which the second predetermined range has been cropped out as the to-be-displayed rear-view image (S102).

Next, image processor 13 sets a color of a frame to be provided on the periphery of the to-be-displayed rear-view image to red (S103), Subsequently a process of S110 is performed.

When the vehicle is not at a stop (NO in S101), image processor 13 determines whether the vehicle speed is greater than or equal to the predetermined speed (S104).

When the vehicle speed is greater than or equal to the predetermined speed (YES in S104), image processor 13 crops out the predetermined range (the first predetermined range) corresponding to the lower portion of the rear-view image and sets the rear-view image from which the first predetermined range has been cropped out as the to-be-displayed rear-view image (S105).

Next, image processor 13 sets a color of a frame to be provided on the periphery of the to-be-displayed rear-view image to blue (S106), Subsequently the process of S110 is performed.

When the vehicle speed is less than the predetermined speed (NO in S104), image processor 13 determines the range corresponding to the lower portion of the rear-view image to be cropped out and the range corresponding to both the end portions of the rear-view image to be cropped out in accordance with the vehicle speed (S107).

Next, image processor 13 crops out the ranges thus determined from the rear-view image and sets the rear-view image from which the ranges determined have been cropped out as the to-be-displayed image (S108).

Next, image processor 13 sets a color of a frame to be provided on the periphery of the to-be-displayed rear-view image to yellow (S109). Subsequently the process of S110 is performed.

After the process of S103, S106, or S109, image processor 13 determines an arrangement of the left-view image and the right-view image in the display area of display 6 (S110).

Image processor 13 arranges the left-view image and the right-view image in accordance with the arrangement thus determined, and composites the left-view image and the right-view image so as to bring the to-be-displayed rear-view image into the foreground (S111).

Through the above-described image processes, image processor 13 generates the to-be-displayed rear-view image where the range of the rear-view image to be displayed is restricted in accordance with the vehicle speed. Further, image processor 13 generates the image resulting from compositing the to-be-displayed rear-view image thus generated, the left-view image, and the right-view image and displays the image thus generated on display 6.

Note that, in S110, Sill, when arranging the left-view image and the right-view image, image processor 13 may change a display mode for the left-view image and the right-view image in accordance with the vehicle speed. Hereinafter, an example of the change of the display mode will be described with reference to FIG. 7A to FIG. 7C.

FIG. 7A is a diagram showing another example of the image displayed when the vehicle is at a stop. FIG. 7B is a diagram showing another example of the image displayed when the vehicle is traveling at a speed less than the predetermined speed. FIG. 7C is a diagram showing another example of the image displayed when the vehicle is traveling at a speed greater than or equal to the predetermined speed.

The images shown in FIG. 7A, FIG. 7B, and FIG. 7C are examples of images resulting from composition performed by image processor 13 with the display mode for left-view image L and right-view image R changed in accordance with the vehicle speed based on the images shown in FIG. 5A, 5B, and FIG. 5C.

Image processor 13 changes the display mode to give depth to the image displayed when the vehicle is traveling. Specifically image processor 13 performs an image process for making, for left-view image L and right-view image R, a vertical magnification of a portion further away from a center and closer to either left or right end portions of an image to be displayed greater.

Specifically, image processor 13 makes a vertical magnification of a right end of left-view image L smaller and makes a vertical magnification of a portion closer to a left end greater. Similarly, image processor 13 makes a vertical magnification of a left end of right-view image R smaller and makes a vertical magnification of a portion closer to a right end greater.

Then, image processor 13 makes, as shown in FIG. 7B and FIG. 7C, a difference between the magnification of the right end of left-view image L and the magnification of the left end of left-view image L greater and makes a difference between the magnification of the left end of right-view image R and the magnification of the right end of right-view image R greater as it is made closer to the predetermined speed.

Image processor 13 generates such images as shown in FIG. 7B and FIG. 7C to give depth to the image displayed when the vehicle is traveling. Further, the images shown in FIG. 7B and FIG. 7C allow the driver to easily recognize left-view image L and right-view image R as a left-view image and right-view image of an own vehicle, respectively.

Note that the examples shown in FIG. 7B and FIG. 7C may be further modified as described below.

FIG. 8A is a diagram showing still another example of the image displayed when the vehicle is traveling at a speed less than the predetermined speed. FIG. 8B is a diagram showing yet another example of the image displayed when the vehicle is traveling at a speed greater than or equal to the predetermined speed.

FIG. 8A shows an example of an image that results from cutting out upper portions and lower portions of left-view image L and right-view image R shown in FIG. 7B to make the vertical width equal to vertical width Y1 of FIG. 7A. FIG. 8B shows an example of an image that results from cutting out the upper portions and the lower portions of left-view image L and right-view image R shown in FIG. 7C to make the vertical width equal to vertical width Y1 of FIG. 7A.

Image processor 13 generates such images as shown in FIG. 8A and FIG. 8B that have the vertical width uniform in accordance with the vehicle speed, which gives depth to the image displayed when the vehicle is traveling and allows display 6 having a limited display area to display an image having a uniform vertical width.

As described above, according to the exemplary embodiment, image processor 13 generates the to-be-displayed rear-view image where the range of the rear-view image to be displayed is restricted in accordance with the vehicle speed. Further, image processor 13 generates the image that results from compositing the to-be-displayed rear-view image thus generated, the left-view image, and the right-view image and displays the image thus generated on display 6. This configuration allows the ranges shown only in the left-view image and the right-view image to be displayed. The configuration further restricts the display of the lower portion of the rear-view image that changes faster as the vehicle speed increases when the vehicle is traveling and allows the lower portion of the rear-view image to be displayed when the vehicle is at a stop. This prevents the volume of information to be viewed by the driver from being excessive and allows information necessary for the driver to be displayed.

Note that, in the exemplary embodiment, a description has been given of the example where image processor 13 performs the image process in accordance with the vehicle speed, but image processor 13 may perform the image process in accordance with the vehicle speed and a period where the vehicle speed is kept constant. For example, when a state where the vehicle speed is greater than or equal to the predetermined speed continues for a certain period, image processor 13 may perform the image process for generating the image shown in MG. 5C. Further, when a state where the vehicle speed is zero continues for a certain period, image processor 13 may perform the image process for generating the image shown in FIG. 5A. This configuration allows the image to be displayed on the display to have a hysteresis characteristic, which prevents the image to be displayed from frequently changing under a travel state where the vehicle speed frequently changes.

Further, in the exemplary embodiment, a description has been given of the example where image processor 13 crops the rear-view image to make the to-be-displayed rear-view image, but the present invention is not limited to this example. As long as part of the rear-view image is prevented from being displayed, the present invention is not limited to the example where the rear-view image is cropped. For example, image processor 13 may superimpose a mask on part of the rear-view image to prevent the part of the rear-view image from being displayed.

Further, in the exemplary embodiment, a description has been given of the example where image processor 13 performs the image process in accordance with the vehicle speed, but image processor 13 may perform the image process in accordance with information indicating a different travel state. For example, image processor 13 may acquire; as information indicating a travel state, information on acceleration or a steering angle or operation information on blinkers and perform the image process in accordance with such information.

For example, image processor 13 may acquire the acceleration from travel state detector 12 and perform the image process in accordance with a vehicle speed calculated from the acceleration. Alternatively, image processor 13 may determine, based on the acceleration, a speed at which the transition of the image displayed on display 6 is made.

Further, image processor 13 may estimate, based on the information on the steering angle or the operation information on the blinkers, a direction in which the vehicle turns and perform an image process for causing the image corresponding to the direction in which the vehicle turns to be displayed such that the driver easily views the image.

Specifically; when the vehicle turns to the right, image processor 13 performs an image process for bringing a corresponding image, that is; the left-view image; into the foreground. Further, when the vehicle turns to the left, image processor 13 performs an image process for bringing a corresponding image, that is, the right-view image, into the foreground.

Alternatively image processor 13 may perform an image process for replacing only a side-view image corresponding to the direction in which the vehicle turns with a representation having depth shown in FIG. 7B or FIG. F G.

Further, in the exemplary embodiment, a description has been given of the example where, when the vehicle is at a stop, image processor 13 generates the image shown in FIG. 5A, but the present invention is not limited to this example. For example, when the vehicle is at a stop or is traveling at a low speed, image processor 13 may generate the image shown in FIG. 5A.

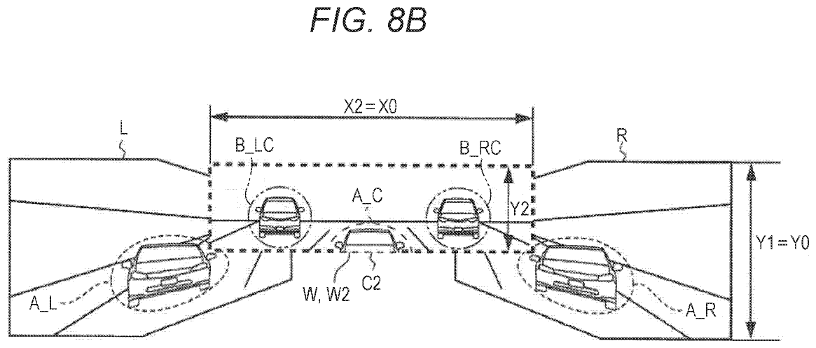

In this case, image processor 13 sets the predetermined speed as a first threshold and sets a second threshold that is less than the first threshold, compares each of the two thresholds with the vehicle speed, and then performs the image process in accordance with the comparison result. Specifically when the vehicle speed is greater than or equal to the first threshold, image processor 13 generates the image shown in FIG. 50, and when the vehicle speed is less than the second threshold, image processor 13 generates the image shown in FIG. 5A. Then, when the vehicle speed is greater than or equal to the second threshold and is less than the first threshold, image processor 13 generates the image shown in FIG. 5B in accordance with a magnitude of the vehicle speed.

Further, in the exemplary embodiment, a description has been mainly given of the image processes performed when vehicle is at a stop and when the vehicle is traveling in the forward direction, but the present invention is not limited to the image processes. For example, when the vehicle is traveling in the backward direction, image processor 13 may perform the same image process as the image process performed when the vehicle is at a stop to generate the image to be displayed on the display.

Further, some or all of the functional blocks used for the description of the exemplary embodiment nay be implemented as a part of a large-scale integration (LSI) circuit or an electronic control unit (ECU) controlling the vehicle, for example.

While the exemplary embodiment according to the present invention has been described above with reference to the drawings, the respective functions of the above-described devices may be implemented by a computer program.

A reading device of a computer that causes the program to implement the respective functions of the devices reads the program for implementing the respective functions of the devices from a recording medium in which the program is recorded and stores the program in a storage device. Alternatively, a network card communicates with a server device connected to a network to download the program for implementing the respective functions of the devices from the server device and stores the program in the storage device.

A central processing unit (CPU) copies the program stored in the storage device to a random-access memory (RAM), and fetches instructions in the program one by one from the RAM and executes the instruction thus fetched, thereby achieves the respective functions of the devices.

### INDUSTRIAL APPLICABILITY

The present invention is suitably applied to a display device of a vehicle.

### REFERENCE MARKS IN THE DRAWINGS

1: display control device
2: left-view imaging unit
3: rear-view imaging unit
4: right-view imaging unit
5: vehicle speed sensor
6: display
11: image acquisition unit
12: travel state detector
13: image processor

1. A display control device comprising:
an image acquisition unit that acquires a first image corresponding to a rear view from a vehicle, a second image corresponding to a left view from the vehicle in a rearward direction, and a third image corresponding to a right view from the vehicle in the rearward direction;
a travel state detector that detects a speed of the vehicle; and
an image processor that generates, when the speed is greater than or equal to a first threshold, an image by superimposing a fourth image on the second image and the third image, the fourth image resulting from preventing a first predetermined range corresponding to a lower portion of the first image from being displayed, and generates, when the speed is less than a second threshold, an image by superimposing a fifth image on the second image and the third image, the fifth image resulting from preventing a second predetermined range corresponding to both end portions of the first image from being displayed.

2. The display control device according to claim 1, wherein
the image processor generates, when a state where the speed is greater than or equal to the first threshold continues for a certain period, an image by superimposing the fourth image on the second image and the third image, and
generates, when a state where the speed is less than the second threshold continues for a certain period, an image by superimposing the fifth image on the second image and the third image.

3. The display control device according to claim 1, wherein
when the speed is greater than or equal to the second threshold and is less than the first threshold,
the image processor: decreases the first predetermined range as a difference between the first threshold and the speed becomes larger;
decreases the second predetermined range as the difference between the first threshold and the speed becomes smaller;
sets a sixth image resulting from preventing the first predetermined range and the second predetermined range of the first image from being displayed; and
generates an image by superimposing the sixth image on the second image and the third image.

4. The display control device according to claim 3, wherein
the image processor sets a first frame on a periphery of the fourth image, sets a second frame on a periphery of the fifth image, and sets a third frame on a periphery of the sixth image, and
the first frame, the second frame, and the third frame are different from each other in display mode.

5. The display control device according to claim 1, wherein
the image processor makes, when the speed is not zero, a vertical magnification of the second image and the third image such that the vertical magnification increases from sides closer to a center of the image to be generated by the superimposing to sides closer to each end of the image to be generated by the superimposing, and
the image processor makes a difference in the vertical magnification between the sides closer to the center to the sides closer to the each end greater as the difference between the first threshold and the speed becomes smaller.

6. The display control device according to claim 1, wherein
the travel state detector detects information indicating a direction in which the vehicle turns, and
the image processor changes a magnification of an image corresponding to the direction in which the vehicle turns.

7. A display control method comprising:
acquiring a first image corresponding to a rear view from a vehicle, a second image corresponding to a left view from the vehicle in a rearward direction, and a third image corresponding to a right view from the vehicle in the rearward direction;
detecting a speed of the vehicle; and
generating, when the speed is greater than or equal to a first threshold, an image by superimposing a fourth image on the second image and the third image, the fourth image resulting from preventing a first predetermined range corresponding to a lower portion of the first image from being displayed, and
generating, when the speed is less than a second threshold, an image by superimposing a fifth image on the second image and the third image, the fifth image resulting from preventing a second predetermined range corresponding to both end portions of the first image from being displayed.
